(19) United States
(12) Patent Application Publication
(10) Pub. No.: US 2009/0121989 A1
(43) Pub. Date: May 14, 2009

(54) ACTIVE MATRIX DEVICE, ELECTROOPTIC DISPLAY, AND ELECTRONIC APPARATUS

(75) Inventor: Isamu NAMOSE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/254,408

(22) Filed: Oct. 20, 2008

(30) Foreign Application Priority Data
Nov. 9, 2007 (JP) 2007-292612

(51) Int. Cl. G09G 3/36

(52) U.S. Cl. 345/85

(57) ABSTRACT

An active matrix device includes: a plurality of pixel electrodes provided above a surface of the substrate; a plurality of switching elements provided so as to correspond to the pixel electrodes, each switching element including: a fixed electrode coupled to one of the pixel electrodes; a movable electrode provided so as to come into contact with or depart from the fixed electrode; and a drive electrode provided so as to be opposed to the movable electrode with an electrostatic gap therebetween; a plurality of first wiring lines coupled to the movable electrodes; and a plurality of second wiring lines coupled to the drive electrodes. Application of a voltage between the movable electrode and the drive electrode generates electrostatic attraction therebetween. The movable electrode is moved by the electrostatic attraction so that the movable electrode comes into contact with the fixed electrode so as to establish continuity between the first wiring line and the corresponding pixel electrode. At least space between the movable electrode and the drive electrode of each of the switching elements is filled with liquid crystal.

### BACKGROUND

1. Technical Field

The present invention relates to an active matrix device, an electrooptic display, and an electronic apparatus.

2. Related Art

A liquid crystal display (LCD) panel that employs the active matrix drive method includes, for example, an active matrix device including multiple pixel electrodes, switching elements provided so as to correspond to the pixel electrodes, and wiring lines coupled to the switching elements (for example, see JP-A-2004-6782).

In general, a thin film transistor (TFT) is used as a switching element in an active matrix device. An a-Si thin film or a p-Si thin film, both of which are photoconductive, is used as a semiconductor layer in such a TFT. Therefore, entry of light into a TFT may cause light leakage thereby reducing the off resistance of the TFT or shifting the threshold of the TFT.

In order to solve the above-described problems caused by the light leakage, a shading layer for shading a TFT from light, such as a black matrix, is provided. However, such a shading layer reduces the aperture ratio of the panel thereby reducing the amount of light that passes through the panel.

In view of the foregoing, an active matrix device (backplane for an electrooptic display) according to JP-A-2004-6782 uses a mechanical switching element instead of a TFT as described above. Such a mechanical switching element causes no light leakage. Therefore, there is no need to provide a shading layer so that the aperture ratio is increased. Further, the switching element has an excellent switching characteristic, since the characteristics of the switching element do not vary with the temperature unlike a TFT.

Also, in the switching element according to JP-A-2004-6782, an actuator electrode is provided so as to be opposed to a cantilever. By energizing the actuator electrode, electrostatic attraction is caused between the actuator electrode and cantilever. The electrostatic attraction moves the cantilever so that the cantilever comes into contact with a pixel electrode. As a result, continuity is established between the pixel electrode and a wiring line.

However, as for the above-described active matrix device, the cantilever may come into contact with and adhere to the actuator electrode when coming into contact with the pixel electrode. This causes a reduction in the reliability of the active matrix device.

Also, it is desirable to reduce the cost of an active matrix device, as a matter of course.

### SUMMARY

An advantage of the invention is to provide an active matrix device, an electrooptic display, and an electronic apparatus that are each low-cost and highly reliable as well as have an improved aperture ratio.

According to a first aspect of the invention, an active matrix device includes: a plurality of pixel electrodes provided above a surface of the substrate; a plurality of switching elements provided so as to correspond to the pixel electrodes, each switching element including: a fixed electrode coupled to one of the pixel electrodes; a movable electrode provided so as to come into contact with or depart from the fixed electrode; and a drive electrode provided so as to be opposed to the movable electrode with an electrostatic gap therebetween; a plurality of first wiring lines coupled to the movable electrodes; and a plurality of second wiring lines coupled to the drive electrodes. Application of a voltage between the movable electrode and the drive electrode generates electrostatic attraction therebetween. The movable electrode is moved by the electrostatic attraction so that the movable electrode comes into contact with the fixed electrode so as to establish continuity between the first wiring line and the corresponding pixel electrode. At least space between the movable electrode and the drive electrode of each of the switching elements is filled with liquid crystal.

According to this configuration, an active matrix device that is low-cost and highly reliable as well as has an improved aperture ratio is provided.

The active matrix device according to the first aspect of the invention preferably further includes a plurality of storages provided in the switching elements and each intended to store the movable electrode, the drive electrode, and the fixed electrode. Each storage is preferably filled with the liquid crystal.

According to this configuration, the switching elements are prevented from affecting each other. As a result, the reliability of the active matrix device is improved.

In the active matrix device according to the first aspect of the invention, a liquid crystal layer is preferably provided on sides of the pixel electrodes opposite to sides thereof facing the switching elements. The liquid crystal filling the storages is preferably of a type identical to a type of liquid crystal included in the liquid crystal layer.

According to this configuration, there is no need to additionally prepare liquid crystal for filling the space between the movable electrode and drive electrode. This makes the active matrix device more low-cost.

In the active matrix device according to the first aspect of the invention, the liquid crystal layer preferably communicates with the storages.

According to this configuration, a step of filling the storages with the liquid crystal and a step of forming a liquid crystal layer are performed in the same step when manufacturing a liquid crystal panel including the active matrix device according to the first aspect of the invention. As a result, the cost of the active matrix device is reduced.

In the active matrix device according to the first aspect of the invention, the liquid crystal is preferably non-conductive and mold-releasable.

According to this configuration, an accidental short circuit among the movable electrode, drive electrode, and fixed electrode is prevented. Also, adhesion between the movable electrode and drive electrode is prevented.

In the active matrix device according to the first aspect of the invention, the liquid crystal is preferably fluoro liquid crystal.

According to this configuration, adhesion between the movable electrode and drive electrode is more reliably prevented.

In the active matrix device according to the first aspect of the invention, the fixed electrode, the movable electrode, and the drive electrode are preferably disposed so that the movable electrode comes into contact with the fixed electrode with the movable electrode and the drive electrode kept separated.

According to this configuration, adhesion between the movable electrode and drive electrode is prevented.

In the active matrix device according to the first aspect of the invention, the movable electrode is preferably supported in a cantilever manner so that a free end thereof is moved, the fixed electrode is preferably provided so as to be opposed to the free end of the movable electrode, and the drive electrode is preferably provided so as to be opposed to a portion of the movable electrode closer to a fixed end of the movable electrode than a portion of the movable electrode to which the fixed electrode is opposed.

According to this configuration, adhesion between the movable electrode and drive electrode is prevented in each switching element having a simplified structure. Also, since the drive electrode is opposed to the portion of the movable electrode near the fixed end thereof, a large reaction force by which the movable electrode attempts to return to its original state is exerted when the movable electrode is moved (bending-deformed) toward the drive electrode. As a result, adhesion between the drive electrode and movable electrode is reliably prevented.

In the active matrix device according to the first aspect of the invention, the pixel electrodes are preferably provided in positions different from positions of the switching elements in a thickness direction of the substrate as well as provided so as to cover the corresponding switching elements in a plan view.

According to this configuration, the aperture ratio is improved.

In the active matrix device according to the first aspect of the invention, the first wiring lines are preferably provided in parallel with each other along the substrate, the second wiring lines preferably intersect the first wiring lines as well as are provided in parallel with each other along the substrate, and the switching elements are preferably provided near intersections of the first wiring lines and second wiring lines.

According to this configuration, the multiple switching elements are disposed so as to correspond to the multiple pixel electrodes disposed in a matrix.

An electrooptic display according to a second aspect of the invention includes the active matrix device according to the first aspect of the invention.

According to this configuration, the electrooptic display has high reliability and displays high-definition images.

An electronic apparatus according to a third aspect of the invention includes the electrooptic display according to the second aspect of the invention.

According to this configuration, the electronic apparatus has high reliability and displays high-definition images.

### BRIEF DESCRIPTION OF THE DRAWINGS

The invention will be described with reference to the accompanying drawings, wherein like numbers reference like elements.

FIG. 1 is a plan view showing an active matrix device according to an embodiment of the invention.

FIG. 2 is a sectional view taken along line A-A of FIG. 1.

FIG. 3 is a perspective view showing a switching element shown in FIG. 2.

FIG. 4 is a drawing showing an operation of the switching element shown in FIG. 2.

FIGS. 5A to 5D are drawings showing a method for manufacturing the active matrix device shown in FIG. 1.

FIGS. 6A to 6D are drawings showing a method for manufacturing the active matrix device shown in FIG. 1.

FIG. 7 is a longitudinal sectional view showing a configuration of a liquid crystal panel that is an example of an electrooptic display according to the invention.

FIG. 8 is a perspective view showing a configuration of a mobile (or notebook) personal computer that is a first example of an electronic apparatus according to the invention.

FIG. 9 is a perspective view showing a configuration of a cell phone (may be a personal handyphone system (PHS)) that is a second example of the electronic apparatus according to the invention.

FIG. 10 is a perspective view showing a configuration of a digital still camera that is a third example of the electronic apparatus according to the invention.

FIG. 11 is a drawing schematically showing an optical system of a projection display that is a fourth example of the electronic apparatus according to the invention.

### DESCRIPTION OF EXEMPLARY EMBODIMENTS

An active matrix device according to an embodiment of the invention, and an electrooptic display and an electronic apparatus according to the invention will now be described with reference to the accompanying drawings.

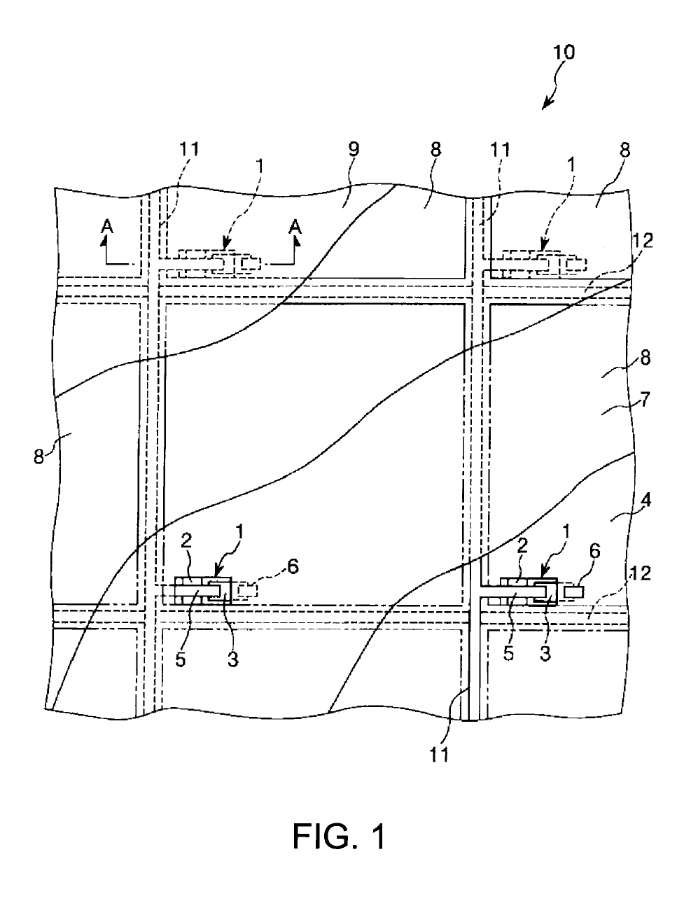

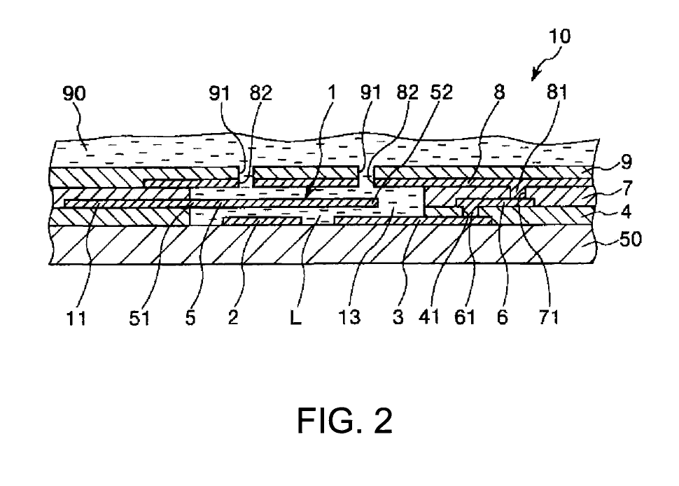

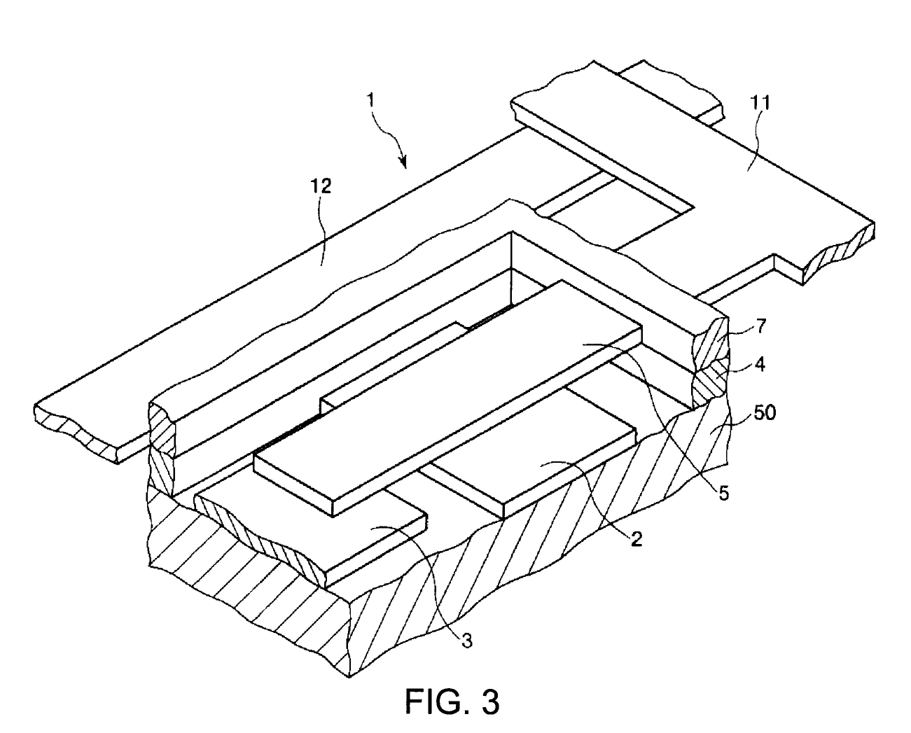

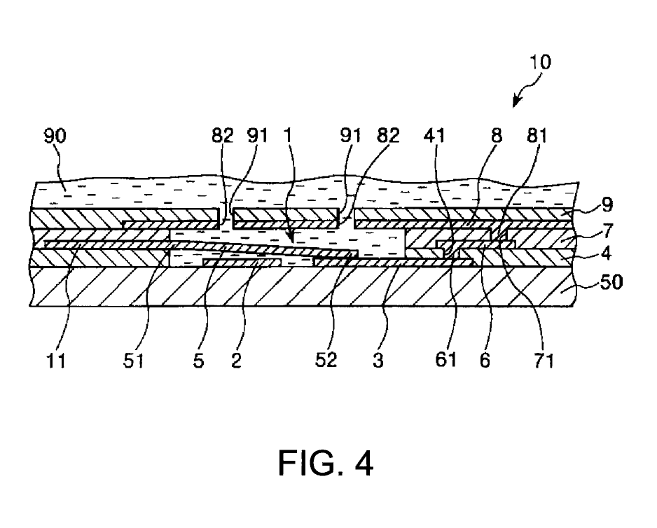

FIG. 1 is a plan view showing an active matrix device according to this embodiment. FIG. 2 is a sectional view taken along line A-A of FIG. 1. FIG. 3 is a perspective view showing a switching element shown in FIG. 2. FIG. 4 is a drawing showing an operation of the switching element shown in FIG. 2. For the sake of convenience, a front side of FIG. 1 will be referred to as “upper,” a backside thereof as “lower,” a right side thereof as “right,” and a left side thereof as “left.” Also, upper sides of FIGS. 2 and 4 will be referred to as “upper,” lower sides thereof as “lower,” right sides thereof as “right,” and left sides thereof as “left.”

Active Matrix Device

An active matrix device 10 shown in FIG. 1 includes multiple first wiring lines 11, multiple second wiring lines 12 provided so as to intersect the first wiring lines, multiple switching elements 1 provided near intersections of the first wiring lines and second wiring lines, and multiple pixel electrodes 8 provided so as to correspond to the switching elements 1. These components are provided on a substrate 50.

The substrate 50 is an entity (supporter) supporting the components (layers) of the active matrix device 10.

For example, the substrate 50 may be a glass substrate, a plastic substrate (resin substrate) made of polyimide, polyethylene terephthalate (PET), polyethylene naphthalate (PEN), polymethyl methacrylate (PMMA), polycarbonate (PC), polyethersulfone (PES), aromatic polyester (liquid crystal polymer), or the like, a quartz substrate, a silicon substrate, a gallium arsenide substrate, or the like.

The average thickness of the substrate 50 depends on the material thereof or the like. While the average thickness is not limited to any particular thickness, it is preferably on the order of 10 to 2000 μm and more preferably on the order of 30 to 300 μm. If the thickness of the substrate 50 is too small, the strength of the substrate 50 is reduced so that the function of the substrate 50 as a supporter may be impaired. On the other hand, too large a thickness of the substrate 50 is unpreferable in terms of weight reduction.

The first wiring lines 11 are provided in parallel with each other along the substrate 50. The second wiring lines 12 intersect the first wiring lines 11 and are provided in parallel with each other along the substrate 50.

In this embodiment, the first wiring lines 11 and second wiring lines 12 are disposed so as to be perpendicular to each other. The first wiring lines 11 are intended to select a row, while the second wiring lines 12 are intended to select a column. That is, one of the first wiring lines 11 and second wiring lines 12 are data lines and the other are scan lines. By selecting a row and a column using the first wiring lines 11 and second wiring lines 12, a desired switching element 1 is selectively operated (a voltage is applied between a movable electrode 5 and a drive electrode 2).

The switching elements 1 are provided near the intersections of the first wiring lines 11 and second wiring lines 12 disposed in this way so that the switching elements 1 are disposed so as to correspond to the pixel electrodes 8 disposed in a matrix.

The materials of the first wiring lines 11 and second wiring lines 12 are not limited to any particular ones as long as they are conductive. For example, the materials may be conductive materials, such as Pd, Pt, Au, W, Ta, Mo, Al, Cr, Ti, Cu, or an alloy including these materials, conductive oxides such as indium tin oxide (ITO), fluorine-doped tin oxide (FTO), antimony-doped tin oxide (ATO), or SnO₂, carbon materials such as carbon black, carbon nanotube, or fullerene, conductive polymeric materials such as polyacetylene, polypyrrole, polythiophene (e.g., poly-ethylenedioxythiophene (PEDOT)), polyaniline, poly (p-phenylene), polyfluorene, polycarbazole, or a derivative thereof, or combinations of two or more of these materials. The above-described polymeric materials are generally doped with high polymers such as iron oxide, iodine, inorganic acid, organic acid, or polystyrene sulfonic acid and used in a conductive state. Among the above-described materials, materials mainly made of Al, Au, Cr, Ni, Cu, Pt or an alloy including these materials are preferably used as the materials of the first wiring lines 11 and second wiring lines 12. Use of these metal materials allows forming the first wiring lines 11 and second wiring lines 12 with ease and a low cost by electrolytic plating or electroless plating. Also, the characteristics of the active matrix device 10 are improved.

In this embodiment, the first wiring lines 11 are provided above one surface (upper surface) of the substrate 50. Also, a first insulating layer 4 is provided on the surface of the substrate 50 so as to cover the first wiring lines 11. On the other hand, the second wiring lines 12 and a conductive layer 6 are provided on a surface (upper surface) of the first insulating layer 4 opposite to a surface thereof facing the substrate 50. Also, a second insulating layer 7 is provided on the upper surface of the first insulating layer 4 so as to cover the second wiring lines 12 and conductive layer 6.

The insulating layer 4 and second insulating layer 7 are both partially eliminated so that storages (eliminated parts) 13 (to be described later) for storing the drive parts of the switching elements 1 are formed. The first insulating layer 4 has through holes (contact holes) 41 for connecting to conductive layers 6 to be described later. Also, the second insulating layer 7 has through holes (contact holes) 71 for connecting to the pixel electrodes 8 to be described later.

The materials of the first insulating layer 4 and second insulating layer 7 are not limited to any particular ones as long as they are nonconductive. The materials may be various types of organic materials (in particular, organic polymeric materials) or various types of inorganic materials.

Among nonconductive organic materials are acrylic resins such as polystyrene, polyimide, polyamide imide, polyvinylphenylene, polycarbonate (PC), and polymethyl methacrylate (PMMA), fluororesins such as polytetrafluoroethylene (PTFE), phenol resins such as polyvinylphenol and novolac resin, and olefin resins such as polyethylene, polypropylene, polyisobutylene, and polybutene. Two or more types of these materials may be combined.

Among nonconductive inorganic materials are metal oxides such as silica (SiO₂), silicon nitride, aluminum oxide, and tantalum oxide, and metal complex oxides such as barium strontium titanate and zirconium titanium acid lead. Two or more types of these materials may be combined.

The conductive layers 6 are intended to couple the fixed electrodes 3 and pixel electrodes 8 electrically. The conductive layers 6 have through electrodes 61 inserted into the through holes 41 of the first insulating layer 4. Thus, the conductive layers 6 and fixed electrodes 3 are electrically coupled. The material of the conductive layers 6 is not limited to any particular one as long as it is conductive. For example, the material may be the same as those of the first wiring lines 11 and second wiring lines 12.

If a liquid crystal panel 100 to be described later is constructed using the active matrix device 10, the pixel electrodes 8 provided above the surface of the substrate 50 each serve as one of electrodes between which a voltage for driving each pixel is applied. As will be described later, a liquid crystal layer 90 is provided on sides of the pixel electrodes 8 opposite to sides thereof facing the switching elements 1. In this embodiment, each pixel 8 is provided in an area surrounded by adjacent two first wiring lines 11 and adjacent second wiring lines 12 in a plan view.

In particular, the pixel electrodes 8 are provided in positions (upper positions) different from those of the switching elements 8 in the thickness direction of the substrate 50. Each pixel electrode 8 is provided so as to cover the corresponding switching element 1 in a plan view. This increases the area of each pixel electrode 8 as much as possible thereby improving the aperture ratio.

Among examples of the material of the pixel electrodes 8 are metals such as Ni, Pd, Pt, Li, Mg, Ca, Sr, La, Ce, Er, Eu, Sc, Y, Yb, Ag, Cu, Co, Al, Cs and Rb, alloys including these metals, such as MgAg, AlLi, and CuLi, and oxides such as ITO, SnO₂, SnO₂ including Sb, and ZnO including Al. Two or more types of these materials may be combined. If the active matrix device 10 is incorporated into the transmission-type liquid crystal panel 100 to be described, a transparent material is selected from among the above-described materials as the material of the pixel electrodes 8.

Also, the pixel electrodes 8 have through electrode parts 81 inserted into the through holes 71 of the second insulating layer 7. Thus, the pixel electrodes 8 and conductive layer 6 are electrically coupled. A part of the lower surface (a surface of each pixel electrode 8 adjacent to the substrate 50) of each pixel electrode 8 constitutes a part of the wall surface of each storage 13. The pixel electrodes 8 also have through holes 82 for providing an etching liquid when forming the storages 13 in a manufacturing process to be described. The through holes 82 are sealed by a sealing layer 9.

The sealing layer 91 has through holes 91 in positions corresponding to the through holes 82 of the pixel electrodes 8. Thus, the storages 13 and liquid crystal layer 90 communicate with each other. The material of the sealing layer 9 is not limited to any particular one as long as it has a function of sealing the through holes 82. While various types of organic materials and inorganic materials may be used as the material of the sealing layer 9, a polymeric material such as polyimide resin, polyamide imide resin, polyvinyl alcohol, or polytetrafluoroethylene is preferably used. Thus, the sealing layer 9 also serves as an alignment film (to be described later) of the liquid crystal panel 100.

Coupled to the pixel electrodes 8 via the conductive layers 6 are the switching elements 1. By controlling the operation of each switching element 1, the drive of the corresponding pixel is controlled in the liquid crystal panel 100 to be described later.

As shown FIGS. 2 and 3, each switching element 1 includes the drive electrode 2 electrically coupled to the corresponding second wiring line 12, a fixed electrode 3 electrically coupled to the corresponding pixel electrode 8, and the movable electrode (switching piece) 5 electrically coupled to the corresponding first wiring line 11.

Hereafter, the components of each switching element 1 will be described in turn.

The drive electrode 2 is formed so as to protrude from a side of the corresponding second wiring line 12 and is provided on the surface (upper surface) of the substrate 50. Also, the drive electrode 2 is provided so as to be opposed to the movable electrode 5 with an electrostatic gap therebetween. Application of a voltage between the drive electrode 2 and movable electrode 5 generates electrostatic attraction therebetween (electrostatic gap).

The drive electrode 2 is electrically coupled to the corresponding second wiring line 12. In this embodiment, the second wiring lines 12 are also formed on the upper surface (that is, on the surface of the substrate 50 on which the drive electrode 2 is formed) of the substrate 50 so that the drive electrode 2 and the corresponding second wiring line 12 are integral with each other.

The material of the drive electrode 2 is not limited to any particular one as long as it is conductive. For example, the material may be the same as those of the first wiring lines 11 and second wiring lines 12. The thickness of the drive electrode 2 is not limited to any particular one and is preferably on the order of 10 to 1000 nm and more preferably on the order of 50 to 500 nm.

The fixed electrode 3 is provided at a distance from the drive electrode 2 on the surface (upper surface) of the substrate 50. By bringing the movable electrode 5 into contact with the fixed electrode 3, the fixed electrode 3 is electrically coupled to the corresponding first wiring line 11. The fixed electrode 3 is electrically coupled to the corresponding pixel electrode 8 via the corresponding conductive layer 6.

The material of the fixed electrode 3 as described above is not limited to any particular one as long as it is conductive. For example, the material may be the same as those of the first wiring lines 11 and second wiring lines 12. The thickness of the fixed electrode 3 is not limited to any particular one and is preferably on the order of 10 to 1000 nm and more preferably on the order of 50 to 500 nm.

The movable electrode 5 is formed so as to protrude from a side of the corresponding first wiring line 11 as well as to be opposed to the drive electrode 2 and fixed electrode 3.

The movable electrode 5 is in the form of a stripe. An end 51 (left end in FIG. 2) of the movable electrode 5 in the longitudinal direction thereof is fixed and supported by the first insulating layer 4 in a cantilever manner. Thus, a free end 52 of the movable electrode 5 is made movable toward the drive electrode 2 and fixed electrode 3 (downward).

In this way, the movable electrode 5 is provided so as to be movable, specifically so as to come into contact with or depart from the fixed electrode 3.

The material of the movable electrode 5 is not limited to any particular one as long as it is conductive and elastically deformable. For example, the material may be a silicon material such as monocrystal silicon, polycrystalline silicon, amorphous silicon, or silicon carbide, a metal material such as stainless steel, titanium, or aluminum, or a combination of two or more of these materials.

In this embodiment, the drive electrode 2, fixed electrode 3, and movable electrode 5 are stored in each of the storages 13 formed between the pixel electrodes 8 and substrate 50.

The storages 13 may be put under a reduced pressure or filled with non-oxidative gas or an insulating liquid.

In each of the switching elements 1 as described above, when no voltage is applied between the movable electrode 5 and drive electrode 2, the movable electrode 5 and fixed electrode 3 are kept separated as shown in FIGS. 2 and 3 so that continuity from the first wiring line 11 to the pixel electrode 8 is interrupted.

When a voltage is applied between the movable electrode 5 and drive electrode 2, electrostatic attraction is generated therebetween. Thus, as shown in FIG. 4, the movable electrode 5 comes into contact with the fixed electrode 3 so that continuity from the first wiring line 11 to the pixel electrode 8 is established.

The mechanical switching elements 1 as described above have light stability higher than TFTs. Also, the switching elements 1 cause no light leakage unlike TFTs. Therefore, there is no need to provide a shading layer for shielding the switching elements 1 from light, such as a black matrix. As a result, the aperture ratio of the active matrix device 10 is increased. Also, the characteristics of the switching elements 1 do not vary with the temperature; therefore, a cooling mechanism of the active matrix device 10 is simplified. Further, the switching elements 1 are allowed to perform a switching operation more quickly than TFTs.

Also, the storages 13 are filled with liquid crystal F. That is, the space between the movable electrode 5 and drive electrode 2 in each switching element 1 is filled with the liquid crystal F.

The liquid crystal F serves as an adhesion prevention means for preventing adhesion between the drive electrode 2 and movable electrode 5 and is mold-releasable with respect to the movable electrode 5 and/or drive electrode 2. Thus, adhesion between the movable electrode 5 and drive electrode 2 is prevented. As a result, the reliability of the active matrix device 10 is improved.

Particularly, in this embodiment, a storage 13 is provided for each switching element 1. Therefore, for example, the switching elements 1 are prevented from being affected by a flow of the liquid crystal F therebetween. As a result, the reliability of the active matrix device 19 is further improved.

The liquid crystal F may be any liquid crystal molecules as long as the liquid crystal molecules are alignable like nematic liquid crystal and smectic liquid crystal. If the liquid crystal panel is of TN type, it is preferable to form nematic liquid crystal. Among examples of nematic liquid crystal are phenylcyclohexane derivative liquid crystal, biphenyl derivative liquid crystal, byphenylcyclohexane derivative liquid crystal, terphenyl derivative liquid crystal, phenyl ether derivative liquid crystal, phenyl ester derivative liquid crystal, bicyclohexane derivative liquid crystal, azomethine derivative liquid crystal, azoxy derivative liquid crystal, pyrimidine derivative liquid crystal, dioxane derivative liquid crystal, and cubane derivative liquid crystal. Also, these types of nematic liquid crystal molecules may contain a fluoro substituent such as a monofluoro group, a trifluoro group, a trifluoromethyl group, a trifluoromethoxy group, or a difluoromethoxy group.

In particular, it is preferable to use, as the liquid crystal F, liquid crystal having high mold-releasability with respect to the movable electrode 5 and/or drive electrode 2 as well as relatively high non-conductivity in order to cause the liquid crystal to serve as an adhesion prevention means as described above as well as to prevent an accidental short circuit between the electrodes. Specifically, it is preferable to use fluoro liquid crystal (liquid crystal molecules containing a fluoro substituent) as the liquid crystal F.

Also, the liquid crystal F is of the same type as that of liquid crystal included in the liquid crystal layer 90 to be described later. Thus, there is no need to additionally prepare liquid crystal for filling the space between the movable electrode 5 and drive electrode 2. This makes the active matrix device 10 low-cost.

Also, in this embodiment, the liquid crystal layer 90 and storages 13 communicate with each other as described above; therefore, a step of filling the storages 13 with the liquid crystal F and a step of forming the liquid crystal layer 90 are performed in the same step when manufacturing the liquid crystal panel 100 to be described. As a result, the cost of the active matrix device 10 is reduced.

As described above, the movable electrode 5 is supported in a cantilever manner and the free end 52 thereof is movable. The fixed electrode 2 is provided so as to be opposed to the free end 52 of the movable electrode 5, while the drive electrode 3 is provided so as to be opposed to a portion of the movable electrode 5 closer to the fixed end 51 of the movable electrode 5 than a portion of the movable electrode 5 to which the fixed electrode 2 is opposed. As shown in FIG. 4, the fixed electrode 3, drive electrode 2, and movable electrode 5 are provided so that the movable electrode 5 comes into contact with the fixed electrode 3 with the movable electrode 5 and drive electrode 2 kept separated. This also prevents adhesion between the movable electrode 5 and drive electrode 5.

In particular, by supporting the movable electrode 5 in a cantilever manner as described above, the structure of each switching element 1 is simplified. Also, since the drive electrode 2 is opposed to the portion of the movable electrode 5 close to the fixed end thereof, a large reaction force by which the movable electrode 5 attempts to return to its original state is exerted when the movable electrode 5 is moved (bending-deformed) toward the drive electrode 2. This reliably prevents adhesion between the drive electrode 2 and movable electrode 5.

The active matrix device 10 thus configured is low-cost and highly reliable as well as has an improved aperture ratio.

Method for Manufacturing Active Matrix Device

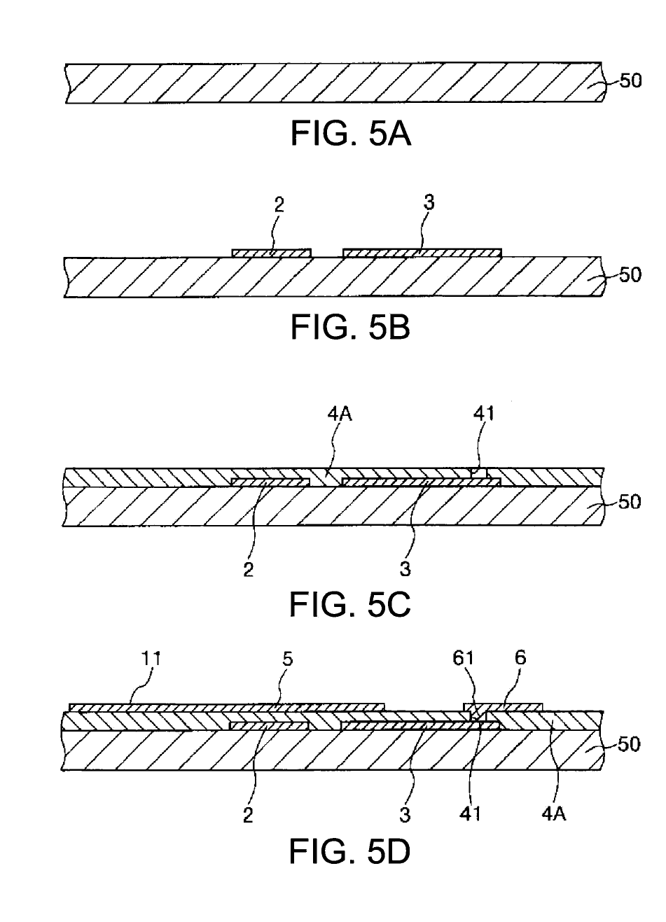

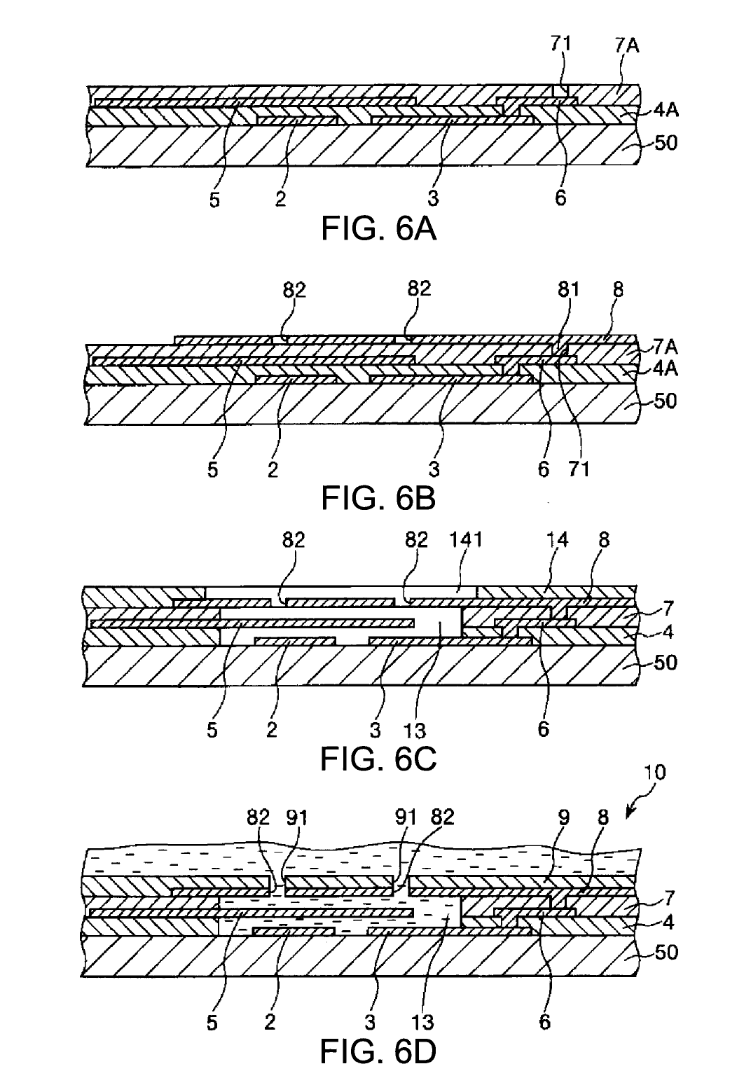

Referring now to FIGS. 5A to 6D, an example of a method for manufacturing the active matrix device 10 according to this embodiment will be described.

FIGS. 5A to 6D are drawings showing a method (method for manufacturing a switching element) for manufacturing the active matrix device shown in FIGS. 1 and 2. For the sake of convenience, upper sides of FIGS. 5A to 6D will be referred to as “upper,” lower sides thereof as “lower”, left sides thereof as “left,” and right sides thereof as “right.”

The method for manufacturing the active matrix device 10 includes: (A) a step of forming the drive electrode 2 and fixed electrode 3 on the substrate 50; (B) a step of forming a first insulating film that is to become the first insulating layer 4; (C) a step of forming the movable electrode 5 and conductive layer 6 on the first insulating film; (D) a step of forming a second insulating film that is to become the second insulating layer 7; (E) a step of forming the pixel electrode 8 on the second insulating film; (F) a step of forming the first insulating layer 4 and second insulating layer 7 by partially eliminating (forming the storage 13) the first and second insulating films; and (G) a step of forming the sealing layer 9.

The above-described steps will be sequentially described in detail.

(A)

First, as shown in FIG. 5A, the substrate 50 is prepared. Then, as shown in FIG. 5B, the drive electrode 2 and fixed electrode 3 are formed on the substrate 50. Simultaneously, the second wiring line 12 (not shown) is also formed. Hereafter, the drive electrode 2, fixed electrode 3, and second wiring line 12 will be referred to as the “drive electrode 2, fixed electrode 3, and the like.”

When the “drive electrode 2, fixed electrode 3, and the like are formed, for example, a metal film (metal layer) is formed first.

While the material of the metal film is not limited to any particular one, the material may be those of the drive electrode 2 and fixed electrode 3 and Al is preferably used. Use of Al as the material of the metal film improves the conductivities of the drive electrode 3, fixed electrode 3, and the like, as well as relatively easily improves the size accuracies of the drive electrode 3, fixed electrode 3, and the like.

This metal film is formed by chemical vapor deposition (CVD) such as plasma CVD, thermal CVD, or laser CVD, dry plating such as vacuum deposition, sputtering (low-temperature sputtering), or ion-plating, wet plating such as electrolytic plating, dip-plating, or electroless plating, flame spraying, a sol-gel process, metal organic deposition (MOD), metal-foil bonding, or the like.

A resist layer having shapes corresponding to those of the drive electrode 2, fixed electrode 3, and the like is formed on the metal film by photolithography. Unnecessary parts of the metal film are eliminated using the resist layer as a mask.

For example, the metal film may be eliminated by physical etching such as plasma etching, reactive ion etching, beam etching, or photo-assist etching, chemical etching such as wet etching, or the like, or a combination of two or more of these techniques.

Subsequently, the resist layer is eliminated so that the drive electrode 2, fixed electrode 3, and the like are obtained as shown FIG. 5B.

Alternatively, for example, the drive electrode 2, fixed electrode 3, and the like may be formed by providing a liquid material such as a colloidal liquid (dispersing liquid) containing conductive particles or a liquid material such as a liquid (solution or dispersing liquid) containing conductive polymers on the substrate 50 so as to form a coating, and then subjecting the coating to an after-treatment (e.g., heating, application of an infrared ray or ultrasound, etc.) as necessary.

(B)

Subsequently, as shown FIG. 5C, a first insulating film 4A having the through hole 41 is formed so as to cover the drive electrode 2, fixed electrode 3, and the like. The first insulating film 4A is a film that is to become the first insulating layer 4 in the step (F) to be described later.

For example, if an organic insulating material is used as the material of the first insulating film 4A, the first insulating film 4A is formed by applying (providing) the organic insulating material or a solution including a precursor of the organic insulating material onto the substrate 50 so as to cover the drive electrode 2, fixed electrode 3, and the like, then subjecting a resultant coating to an after-treatment (e.g., heating, application of an infrared ray or ultrasound, etc.) as necessary, then forming a mask having an opening in a portion corresponding to the through hole 41 by photolithography like in the process (B), and etching the coating using the mask.

Among examples of a method for applying (providing) an organic insulating material or a solution including a precursor of the organic insulating material onto the substrate 50 are coating and printing.

If an inorganic material is used as the material of the first insulating film 4A, the first insulating film 4A may be formed, for example, by thermal oxidation, CVD, spin-on-glass, or the like. If polysilazane is used as the material, a silica film or a silicon nitride film is formed as the first insulting film 4A in a wet process.

Subsequently, as shown in FIG. 5D, the first wiring line 11, movable electrode 5, and conductive layer 6 are formed. At that time, the through electrode 61 is formed in the through hole 41 so that the fixed electrode 3 and conductive layer 6 are electrically coupled. Hereafter, the first wiring line 11, movable electrode 5, and conductive layer 6 will be referred to as the “movable electrode 5, conductive layer 6, and the like.”

The movable electrode 5, conductive layer 6, and the like may be formed using the same method as that used in the process (A). If the movable electrode 5 is mainly formed of silicon, the movable electrode 5 may be formed, for example, by forming an α-Si (amorphous silicon) material or silicon carbide by CVD and etching the α-Si or silicon carbide material using the same method as that used in the process (A).

(D)

Subsequently, as shown FIG. 6A, a second insulating film 7A having the through hole 71 is formed so as to cover the movable electrode 5, conductive layer 6, and the like. The second insulating film 7A is a film that is to become the second insulating layer 7 in the process F to be described later. The second insulating layer 7 is formed using the same method as that used in the process (B).

(E)

Subsequently, as shown in FIG. 6B, the pixel electrode 8 having a through hole 82 is formed. The pixel electrode 8 is formed using the same method as that used in the process (A).

(F)

Subsequently, as shown in FIG. 6C, a mask 14 having an opening 141 for exposing the through hole 82 of the pixel electrode 8 is formed. Then, the first insulating layer 4 and second insulating layer 7 are formed by wet-etching the first insulting film 4A and second insulting film 7A using the mask 14 so as to partially eliminate the insulting films 4A and 7A. Thus, the storage 13 for storing the drive electrode 2, fixed electrode 3, and movable electrode 5 is formed.

(G)

Subsequently, the mask 14 is eliminated and then, as shown in FIG. 6D, the sealing layer 9 is formed so as to cover the multiple pixel electrodes 8. Then, the liquid crystal layer 90 is formed so that the storage 13 is filled with the liquid crystal F via a through hole 91 of the sealing layer 9. Thus, the active matrix device 10 (switching element 1) is obtained.

In this way, the active matrix device 10 is manufactured.

Electrooptic Display

Next, a liquid crystal panel including the active matrix device 10 will be described as an example of an electrooptic display according to the invention.

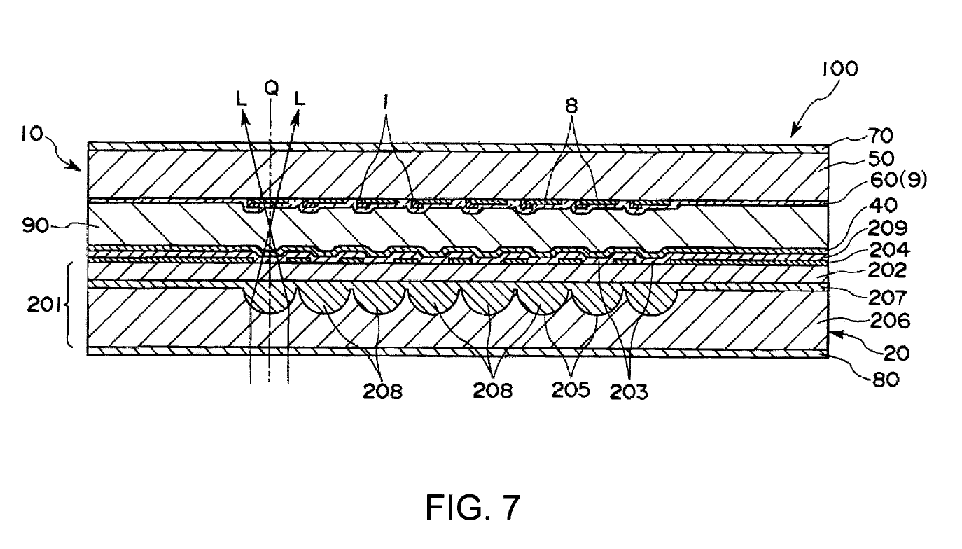

FIG. 7 is a longitudinal sectional view of a liquid crystal panel to which the electrooptic display according to the invention is applied.

As shown in FIG. 7, a liquid crystal panel 100, which is an electrooptic display, includes the above-described active matrix device 10, an alignment film 60 bonded to the active matrix device 10, a counter substrate 20 for a liquid crystal panel, an alignment film 40 bonded to the counter substrate 20, a liquid crystal layer 90 including liquid crystal sealed in a gap between the alignment films 60 and 40, a polarizing film 70 bonded to the outer surface (upper surface) of the active matrix device 10 (liquid crystal device), and a polarizing film 80 bonded to the outer surface (lower surface) of the counter substrate 20.

The counter substrate 20 includes a microlens substrate 201, a black matrix 204 provided on a surface layer 202 of the micro-lens substrate 201 and having openings 203, and a transparent conductive film (common electrode) 209 provided on the surface layer 202 so as to cover the black matrix 204.

The microlens substrate 201 includes a substrate (first substrate) 206 having multiple (many) concave parts 205 for storing microlenses and a surface layer 202 bonded to a surface of the substrate 206 having the concave parts 205 with a resin layer (adhesive layer) 207 therebetween. In the resin layer 207, a resin filling the concave parts 205 forms microlenses 208.

Here, the active matrix device 10 is a device for driving the liquid crystal included in the liquid crystal layer 90. The switching element 1 of the active matrix device 10 is coupled to a control circuit (not shown) and controls a current to be provided to the pixel electrode 8. Thus, the charge and discharge of the pixel electrode 8 is controlled.

The alignment film 60 is bonded to the pixel electrode 8 of the active matrix device 10, while the alignment film 40 is bonded to the liquid crystal layer 90 of the counter substrate 20. Here, the alignment film 60 also serves as the sealing layer 9 of the active matrix device 10.

The alignment films 40 and 60 both have a function of controlling the alignment state (at the time when no voltage is applied) of liquid crystal molecules included in the liquid crystal layer 90.

While the materials of the alignment films 40 and 60 are not limited to any particular ones, these alignment films are typically mainly formed of a polymeric material such as a polyimide resin, a polyamide imide resin, polyvinyl alcohol, or polytetrafluoroethylene. Among such polymeric materials, a polyimide resin and a polyamide imide resin are preferably used. If a polyimide resin or a polyamide imide resin is used as the main materials of the alignment films 40 and 60, polymeric films are formed in a simplified way in the manufacturing process. The polymeric films thus formed are excellent in heat resistance, chemical resistance, and the like.

Typically, films formed of a material as described above are subjected to a process for providing the films an alignment function for controlling the alignment of the liquid crystal included in the liquid crystal layer 90. Thus, the alignment films 40 and 60 are formed. Examples of a process for providing an alignment function include rubbing and photoalignment.

The average thicknesses of these alignment films are preferably 20 to 120 nm and are more preferably 30 to 80 nm.

The liquid crystal layer 90 contains liquid crystal molecules. The alignment of the liquid crystal molecules, that is, the alignment of the liquid crystal is changed in response to the charge or discharge of the pixel electrode 8.

Liquid crystal molecules of the same type as that of the liquid crystal F are used as the liquid crystal molecules of the liquid crystal layer 90.

In the liquid crystal panel 100, one of the microlenses 208, one of the openings 203 of the black matrix 204 corresponding to an optical axis Q of the microlens 208, one of the pixel electrodes 8, and one of the switching elements 1 coupled to the pixel electrode 8 correspond to one pixel.

Incident light L from the counter substrate 20 passes through the substrate 206. When the incident light L passes through the microlenses 208, the incident light is condensed and then passes through the resin layer 207, the surface layer 202, the openings 203 of the black matrix 204, a transparent conductive film 209, the liquid crystal layer 90, the pixel electrode 8, and the substrate 50. Since the polarizing film 80 is provided on a side of the microlens substrate 201 from which the light has entered, the incident light L becomes a linearly polarized light when the incident light L passes through the liquid crystal layer 90. At that time, the polarization direction of the incident light L is controlled according to the alignment state of the liquid crystal molecules included in the liquid crystal layer 90. Thus, the incident light L that has passed through the liquid crystal panel 100 passes through the polarizing film 70. As a result, the luminance of the outgoing light is controlled.

As described above, the liquid crystal panel 100 includes the microlenses 208 and the incident light L that has passed through the microlenses 208 is condensed and then passes through the openings 203 of the black matrix 204. On the other hand, the incident light L is blocked by parts of the black matrix 204 where no opening 203 is formed. Therefore, the liquid crystal panel 100 prevents leakage of unnecessary light from parts other than the pixels, as well as reduces the attenuation of the incident light L in the pixels. As a result, the liquid crystal panel 100 shows high light transmittance in the pixels.

The above-described liquid crystal panel 100 including the active matrix device 10 has high reliability and displays high-definition images.

The application of the electrooptic display according to the invention is not limited to the application to a liquid crystal panel as described above. The electrooptic display according to the invention is also applicable to an electrophoresis display, an organic electroluminescent display, an inorganic electroluminescent display, and the like.

Electronic Apparatus

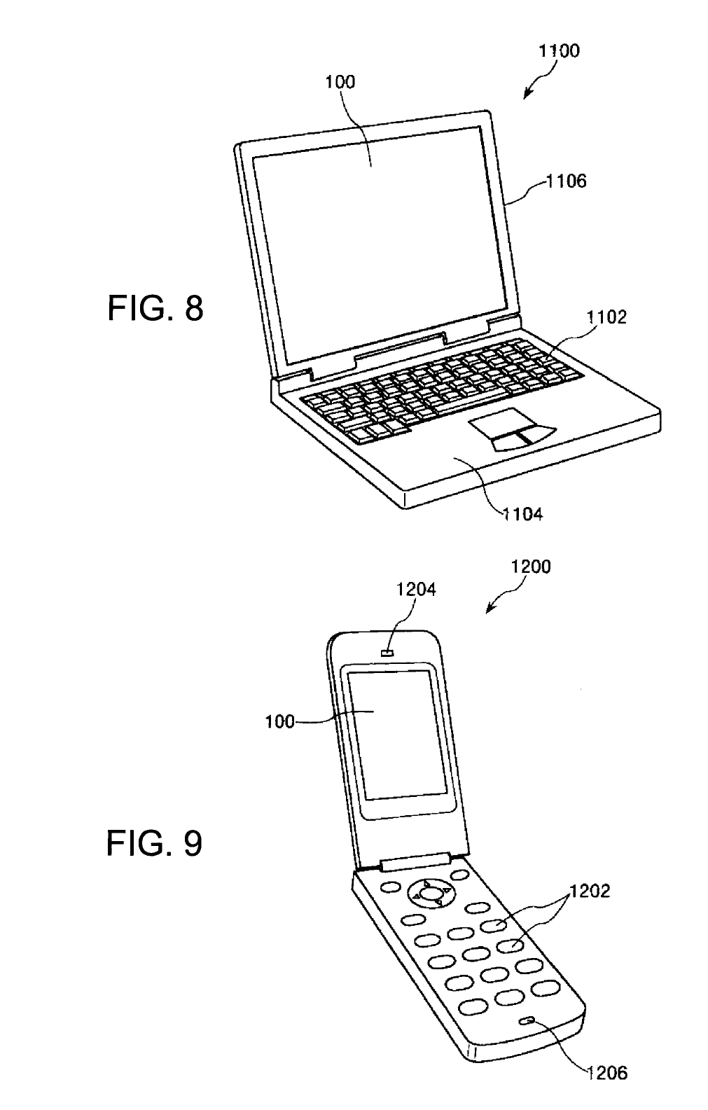

Next, electronic apparatuses including the above-described liquid crystal panel 100 will be described as examples of an electronic apparatus according to the invention with reference to first to fourth examples shown in FIGS. 8 to 11.

### FIRST EXAMPLE

FIG. 8 is a perspective view showing a configuration of a mobile (or notebook) personal computer that is a first example of the electronic apparatus according to the invention. In FIG. 8, a personal computer 1100 includes a main body 1104 having a keyboard 1102 and a display unit 1106. The display unit 1106 is supported by the main body 1104 in such a manner that the display unit 1106 is rotatable about a hinge structure.

In the personal computer 1100, the display unit 1106 includes the above-described liquid crystal panel 100 and a backlight (not shown). The display unit 1106 displays an image (information) by transmitting light from the backlight through the liquid crystal panel 100.

### SECOND EXAMPLE

FIG. 9 is a perspective view showing a configuration of a cell phone (may be a personal handyphone system (PHS)) that is a second example of the electronic apparatus according to the invention. In FIG. 9, a cell phone 1200 includes multiple operation buttons 1202, an earpiece 1204 and a mouthpiece 1206, as well as includes the above-described liquid crystal panel 100 and a backlight (not shown).

### THIRD EXAMPLE

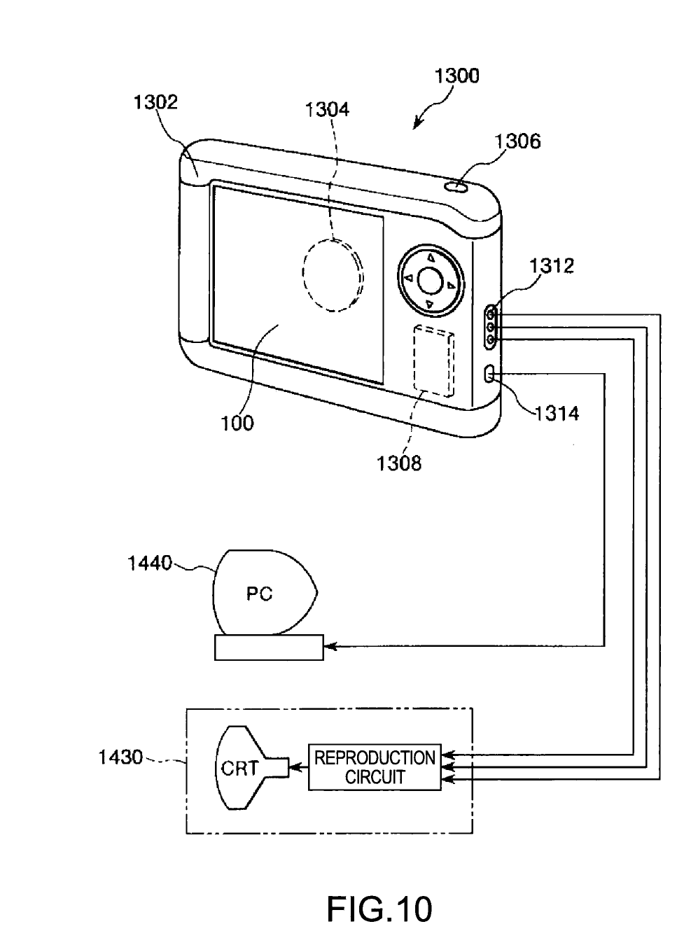

FIG. 10 is a perspective view showing a configuration of a digital still camera that is a third example of the electronic apparatus according to the invention. In FIG. 10, connections to external apparatuses of the digital still camera are also shown in a simplified way. While an ordinary camera exposes a silver salt film to light according to an optical image of an subject, the digital still camera 1300 photoelectrically converts an optical image of a subject using an imaging element such as a charge coupled device (CCD) so as to generate an image signal.

The digital still camera 1300 is provided with the above-described liquid crystal 100 and a backlight (not shown) on the back of a case (body) 1302 thereof so that an image is displayed according to an image signal generated by a CCD. The liquid crystal panel 100 serves as a finder for displaying a subject as an electronic image.

The case 1302 contains a circuit substrate 1308. The circuit substrate 1308 has thereon a memory for storing image signals.

Also, a photoreception unit 1304 including an optical lens (imaging optical system), CCD, and the like is provided on the front side of the case 1302 (on the backside in the illustrated configuration).

If a user identifies a subject image displayed on the liquid crystal panel 100 and then presses a shutter button 1306, an image signal generated by the CCD at that point of time is transferred to the memory on the circuit substrate 1308 and stored therein.

Also, the digital still camera 1300 has a video signal output terminal 1312 and an input/output terminal 1314 for data communication on a side surface of the case 1302. As shown in FIG. 10, a television monitor 1430 is coupled to the video signal output terminal 1312 or a personal computer 1440 is coupled to the input/output terminal 1314 as necessary. In this case, according to a predetermined operation, an image signal stored in the memory on the circuit substrate 1308 is outputted to the television monitor 1430 or personal computer 1440.

### FOURTH EXAMPLE

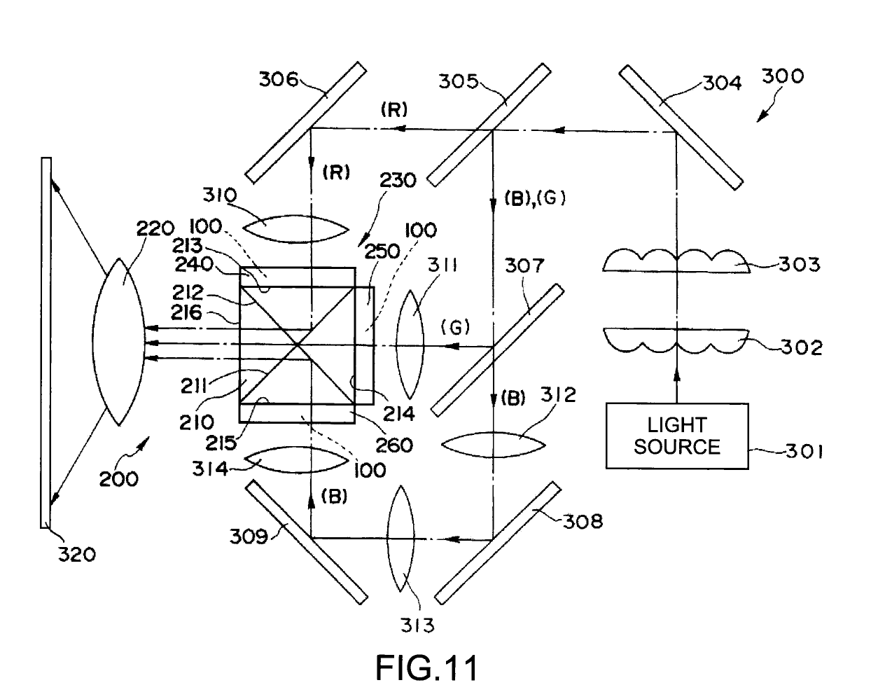

FIG. 11 is a drawing schematically showing an optical system of a projection display (liquid crystal projector) that is a fourth example of the electronic apparatus according to the invention.

As shown in FIG. 11, a projection display 300 includes a light source 301, a lighting optical system including multiple integrator lenses, a color separation optical system (light guiding optical system) including multiple dichroic mirrors and the like, a liquid crystal light valve (liquid crystal light shutter array) 240 for red, a liquid crystal light valve (liquid crystal light shutter array) 250 for green, a liquid crystal light valve (liquid crystal light shutter array) 260 for blue, a dichroic prism (color synthesis optical system) 210 having a dichroic mirror surface 211 for reflecting only red light and a dichroic mirror surface 212 for reflecting blue light, and a projection lens (projection optical system) 220.

The lighting optical system includes integrator lenses 302 and 303. The color separation optical system includes mirrors 304, 306, and 309, a dichroic mirror 305 for reflecting blue light and green light (that is, transmitting only red light), a dichroic mirror 307 for reflecting only green light, a dichroic mirror 308 for reflecting only blue light (or mirror for reflecting blue light) 308, and condenser lenses 310, 311, 312, 313, and 314.

The liquid crystal light valve 250 includes the above-described liquid crystal panel 100. The liquid crystal light valves 240 and 260 also have the same configuration. The liquid crystal panels 100 included in the liquid crystal light valve 240, 250, and 260 are coupled to a drive circuit (not shown).

In the projection display 300, the dichroic prism 210 and projector lens 220 constitute an optical block 200. Also, the optical block 200, and the liquid crystal light valves 240, 250, and 260 fixed to the dichroic prism 210 constitute a display unit 230.

Hereafter, the operations of the projection display 300 will be described.

White light (white light beams) emitted from the light source 301 passes through the integrator lenses 302 and 303. The light intensities (luminance distribution) of the white light are made uniform by the integrator lenses 302 and 303. The white light emitted from the light source 301 preferably has relatively high light intensity. Thus, an image formed on a screen 320 is made sharper. Also, the projector display 300 includes the liquid crystal panel 100 having high light stability; therefore, high stability is obtained for the long term even if the light emitted from the light source 301 has high intensity.

The white light that has passed through the integrator lenses 302 and 303 is reflected toward the left side of FIG. 11 by the mirror 304. Among the reflected light beams, a blue light beam (B) and a green light beam (G) are each reflected toward the lower side of FIG. 11 by the dichroic mirror 305, while a red light beam (R) passes through the dichroic mirror 305.

The red light beam that has passed through the dichroic mirror 305 is reflected toward the lower side of FIG. 11 by the mirror 306. The reflected light beam is shaped by the condenser lens 310 and then enters the liquid crystal light valve 240 for red.

Of the blue light beam and green light beam reflected by the dichroic mirror 305, the green light beam is reflected toward the left side of FIG. 11 by the dichroic mirror 307, while the blue light beam passes through the dichroic mirror 307.

The green light beam reflected by the dichroic mirror 307 is shaped by the condenser lens 311 and then enters the liquid crystal light valve 250 for green.

The blue light beam that has passed through the dichroic mirror 307 is reflected toward the left side of FIG. 11 by the dichroic mirror 308 (or mirror). Then, the reflected light beam is reflected toward the upper side of FIG. 11 by the mirror 309. The blue light beam is shaped by the condenser lenses 312, 313, and 314 and then enters the liquid crystal light valve 260 for blue.

As described above, the white light emitted from the light source 301 is color-separated into light beams having three primary colors, that is, red, green, and blue and then the light beams are guided to and enter the corresponding liquid crystal light valves.

In this case, the pixels (switching elements 1 and pixel electrodes 8 coupled thereto) of the liquid crystal panel 100 included in the liquid crystal light valve 240 are switching-controlled (ON/OFF), that is, modulated by a drive circuit (drive means) that operates according to an image signal for red.

Similarly, the green light beam and blue light beam enter the liquid crystal light valves 250 and 260, respectively, and are modulated by the respective liquid crystal panels 100 so that an image for green and an image for blue are formed. In this case, the pixels of the liquid crystal panel 100 included in the liquid crystal light valve 250 are switching-controlled by a drive circuit that operates according to an image signal for green. Also, the pixels of the liquid crystal panel 100 included in the liquid crystal light valve 260 are switching-controlled by a drive circuit that operates according to an image signal for blue.

Thus, the red light beam, green light beam, and blue light beam are modulated by the liquid crystal light valves 240, 250, and 260 so that an image for red, an image for green, and an image for blue are formed.

The image for red generated by the liquid crystal light valve 240, that is, the red light beam from the liquid crystal light valve 240 enters the dichroic prism 210 via the surface 213, is reflected toward the left side of FIG. 11 by the dichroic mirror surface 211, passes through the dichroic mirror surface 212, and goes out through an outgoing surface 216.

The image for green generated by the liquid crystal light valve 250, that is, the green light beam from the liquid crystal light valve 250 enters the dichroic prism 210 via the surface 214, passes through the dichroic mirror surfaces 211 and 212, and goes out through the outgoing surface 216.

The image for blue generated by the liquid crystal light valve 260, that is, the blue light beam from the liquid crystal light valve 260 enters the dichroic prism 210 via the surface 215, is reflected toward the left side of FIG. 11 by the dichroic mirror surface 212, passes through the dichroic mirror surface 211, and goes out through the outgoing surface 216.

As described above, colored light beams from the liquid crystal light valves 240, 250, and 260, that is, the images generated by the liquid crystal light valves 240, 250, and 260 are synthesized by the dichroic prism 210 so that colored images are formed. These images are projected (projected in an enlarged manner) onto the screen 320 provided in a predetermined position via a projection lens 220.

As is understood from the above-description, the electronic apparatuses including the liquid crystal panel 100 have high reliability as well as display high-definition images.

Examples of the electronic apparatus according to the invention include not only the personal computer (mobile personal computer) shown in FIG. 8, cell phone shown in FIG. 9, digital still camera shown in FIG. 10, and projection display shown in FIG. 11 but also televisions, video cameras, view finder-type or monitor-direct-view-type video tape recorders, car navigation systems, pagers, electronic notepads (including ones with a communication function), electronic dictionaries, electronic calculators, electronic game machines, word processors, workstations, video phones, television monitors for security, electronic binoculars, point-of-sale (POS) terminals, apparatuses with a touch panel (e.g., cash dispensers of financial institutions, automated ticket vending machines), medical equipment (e.g., electronic thermometer, sphygmomanometers, blood sugar meters, electrocardiogram displays, ultrasonic diagnosis apparatuses, displays for an endoscope), fish finders, various measuring instruments, meters (e.g., meters of an automobile, an aircraft, and a ship), and flight simulators. That is, the electrooptic display according to the invention is applicable to the display units or monitors of these various types of electronic apparatuses.

As is understood from the above-description, the electronic devices or electronic apparatuses including the active matrix device 10 have high reliability.

While the active matrix device according to the invention has been described on the basis of the illustrated embodiment, the invention is not limited to the embodiment. While the electrooptic display and electronic apparatus according to the invention have been described on the basis of the illustrated examples, the invention is not limited to those examples.

For example, any component of the active matrix device, electrooptic display, and electronic apparatus according to the invention may be replaced with an arbitrary component having a similar function. Also, an arbitrary component may be added to the active matrix device, electrooptic display, and electronic apparatus according to the invention.

Also, in the above-described embodiment, the storages 13 provided in the switching elements 1 are filled with the liquid crystal F; however, it is sufficient that at least the space between the movable electrode 5 and drive electrode 2 is filled with the liquid crystal F. The form of the storages 13 is not limited to that in the above-described embodiment.

Also, in the above-described embodiment, the storages 13 and liquid crystal layer 90 communicate with each other; however, the storages 13 and liquid crystal layer 90 need not always communicate with each other. In that case, it is preferable to form the sealing layer 9 so that the sealing layer 9 covers the through holes 82 of the pixel electrodes 8.

Also, in the above-described example, the projection display (electronic apparatus) includes three liquid crystal panels and the electrooptic display according to the invention is applied to each of these panels; however, it is sufficient that at least one of these panels is the electrooptic display (liquid crystal panel) according to the invention. In this case, the electrooptic display according to the invention is preferably applied to at least the liquid crystal panel for use in the liquid crystal light valve for blue.

Also, in the above-described example, the electrooptic display according to the invention is a transmission-type electrooptic display; however, without being limited thereto, the electrooptic display according to the invention may be applied to a reflection-type electrooptic display such as a liquid-crystal-on-silicon (LCOS) display.

What is claimed is:

1. An active matrix device comprising:
a plurality of pixel electrodes provided above a surface of a substrate;
a plurality of switching elements provided so as to correspond to the pixel electrodes, each switching element including:
a fixed electrode coupled to one of the pixel electrodes;
a movable electrode provided so as to come into contact with or depart from the fixed electrode; and
a drive electrode provided so as to be opposed to the movable electrode with an electrostatic gap therebetween;
a plurality of first wiring lines coupled to the movable electrodes; and
a plurality of second wiring lines coupled to the drive electrodes, wherein
application of a voltage between the movable electrode and the drive electrode generates electrostatic attraction therebetween, and the movable electrode is moved by the electrostatic attraction so that the movable electrode comes into contact with the fixed electrode so as to establish continuity between the corresponding first wiring line and the corresponding pixel electrode, and
at least space between the movable electrode and the drive electrode of each of the switching elements is filled with liquid crystal.

2. The active matrix device according to claim 1, further comprising
a plurality of storages provided in the switching elements, each storage storing the movable electrode, the drive electrode, and the fixed electrode and being filled with the liquid crystal.

3. The active matrix device according to claim 2, wherein
a liquid crystal layer is provided on sides of the pixel electrodes opposite to sides thereof facing the switching elements, and
the liquid crystal filling the storages is of a type identical to a type of liquid crystal included in the liquid crystal layer.

4. The active matrix device according to claim 3, wherein
the liquid crystal layer communicates with the storages.

5. The active matrix device according to claim 1, wherein
the liquid crystal is non-conductive and mold-releasable.

6. The active matrix device according to claim 5, wherein
the liquid crystal is fluoro liquid crystal.

7. The active matrix device according to claim 1, wherein
the fixed electrode, the movable electrode, and the drive electrode are disposed so that the movable electrode comes into contact with the fixed electrode with the movable electrode and the drive electrode kept separated.

8. The active matrix device according to claim 7, wherein
the movable electrode is supported in a cantilever manner so that a free end thereof is moved,
the fixed electrode is provided so as to be opposed to the free end of the movable electrode, and
the drive electrode is provided so as to be opposed to a portion of the movable electrode closer to a fixed end of the movable electrode than a portion of the movable electrode to which the fixed electrode is opposed.

9. The active matrix device according to claim 1, wherein
the pixel electrodes are provided in positions different from positions of the switching elements in a thickness direction of the substrate as well as provided so as to cover the corresponding switching elements in a plan view.

10. The active matrix device according to claim 1, wherein
the first wiring lines are provided in parallel with each other along the substrate,
the second wiring lines intersect the first wiring lines as well as are provided in parallel with each other along the substrate, and
the switching elements are provided near intersections of the first wiring lines and second wiring lines.

11. An electrooptic display comprising
the active matrix device according to claim 1.

12. An electronic apparatus comprising
the electrooptic display according to claim 11.
